(19) United States
(12) Patent Application Publication
(10) Pub. No.: US 2022/0293993 A1
(43) Pub. Date: Sep. 15, 2022

(54) SOLID OXIDE FUEL CELL SYSTEM HIGH-TEMPERATURE COMPONENT CONNECTING STRUCTURE AND NEW ENERGY AUTOMOBILE

(71) Applicant: Ceres Intellectual Property Company Limited, Horsham West Sussex (GB)

(72) Inventors: Jianhong Gao, Weifang, Shandong (CN); Chunlei Gao, Weifang, Shandong (CN); Xiao Zhang, Weifang, Shandong (CN); Chao Yu, Weifang, Shandong (CN)

(21) Appl. No.: 17/633,090

(22) PCT Filed: Oct. 6, 2020
(86) PCT No.: PCT/IB2020/059354

§ 371 Date: Feb. 4, 2022

(30) Foreign Application Priority Data
Aug. 6, 2019 (CN) 201921273587.8

(51) Int. Cl. H01M 8/2475; H01M 8/04007; H01M 8/12

(52) U.S. Cl. CPC H01M 8/2475; H01M 8/04067; H01M 8/12; H01M 2250/20; H01M 2008/1293

(57) ABSTRACT

A high-temperature component connecting structure of a solid oxide fuel cell system. In order to ensure the high-temperature working condition of the solid oxide fuel cell system, when a high-temperature component is supported by a bottom supporting plate and a fixed mounting plate, a heat insulation plate is arranged between the high-temperature component and the bottom supporting plate to reduce the heat conduction to the high-temperature component and the heat loss and raise the heat efficiency. Meanwhile, because the heat insulation plate has a low strength and a low thermal expansion coefficient, in order to counteract the axial expansion amount of the bolts during work at high temperature and ensure a stable supporting structure of the heat insulation plate, when the heat insulation plate, the bottom supporting plate and the fixed mounting plate are locked through the connecting bolts, supporting columns are arranged in the heat insulation plate in the thickness direction of the heat insulation plate and are sleeved on the connecting bolts to bear the locking force of the connecting bolts to avoid deformation of the heat insulation plate under pressure and ensure the stability of the heat insulation structure. A new energy automobile includes the foregoing solid oxide fuel cell system high-temperature component connecting structure

### TECHNICAL FIELD

The present invention relates to the technical field of new energy automobiles, particularly to a solid oxide fuel cell system high-temperature component connecting structure and a new energy automobile.

### BACKGROUND ART

High-power (above 10 KW) solid oxide fuel cell (SOFC) systems were first used in new energy automobiles as power devices of the new energy automobiles. Fuel cell modules (FCM) are the power generation devices of SOFC. In the working process, the parts in the FCM box need to reach and maintain certain high working temperature so that the cell can work normally. In order to improve the thermal efficiency of the SOFC system, it is necessary to reduce the heat loss in the FCM box.

The operation of the vehicle is accompanied with complex working conditions such as vibration, acceleration, and deceleration, and the parts in the FCM box are in a high-temperature working environment. Therefore, the strength, reliability and stability of the connection of the parts in the box must be guaranteed to ensure the normal operation of the vehicle.

The existing proton exchange membrane fuel cell is in a low temperature working environment (<100° C.). The solid oxide fuel cells below 10 KW feature a small cell system and a small weight, are used for household power generation, not used in passenger cars and are in a stationary state and their working condition is relatively simple.

FIG. 1 is a structural schematic view of connection of an existing ordinary fuel cell. When the cell is fixed and connected, a connected part 1 and a connected part 2 used to fix the cell are directly connected and fixed by ordinary bolts 3, which run through the connected part 1 and the connected part 2. This structure can meet the connection function of parts under normal-temperature working conditions, but for the high temperature working conditions of solid oxide fuel cells, this connection method cannot guarantee the low heat conduction between the parts and the reliability and stability of the connection.

Therefore, how to meet the working stability of high-power fuel cells under high temperature and complex working conditions is a problem.

### SUMMARY OF THE INVENTION

The present invention provides a solid oxide fuel cell system high-temperature component connecting structure to meet the working stability of high-power fuel cells; and further provides a new energy automobile.

A first aspect of the invention provides a solid oxide fuel cell system high-temperature component connecting structure, wherein the solid oxide fuel cell system high-temperature component connecting structure comprises a heat insulation plate, a bottom supporting plate and a fixed mounting plate that are for rack-mounting a high-temperature component and arranged in sequence, and connecting bolts for connecting the heat insulation plate, the bottom supporting plate and the fixed mounting plate are mounted in the high-temperature component.

Supporting columns are arranged in the heat insulation plate in the thickness direction of the heat insulation plate and are sleeved on the connecting bolts to bear the locking force of the connecting bolts and counteract the axial expansion amount of the connecting bolts at high temperature.

A top supporting plate pressed between the heat insulation plate and the high-temperature component can also be provided.

Two guide pin locating holes can also be arranged in the supporting direction of the heat insulation plate, the bottom supporting plate and the fixed mounting plate, are distributed on two sides of the connecting bolts in the radial direction of the connecting bolts and use cylindrical guide pins to locate the installation of the connecting bolts.

Screw seats that are for locking and matching the connecting bolts by means of threads can be mounted on the bottom of the fixed mounting plate in a fixed manner.

Hole seats that are for mounting and matching the cylindrical guide pins can also be mounted on the bottom of the fixed mounting plate in a fixed manner.

Locating holes for mounting and locating the screw seats and the hole seats can be opened on the fixed mounting plate, locating steps for plug-in mounting and matching the locating holes can be opened on the screw seats and the hole seats, and the screw seats and the hole seats can all be mounted on the fixed mounting plate by means of welding.

A side plate can be extended from the bottom supporting plate, around the circumference of the heat insulation plate and protects the heat insulation plate.

An insertion slot arranged in parallel with the circumference of the heat insulation plate can be opened on the bottom supporting plate, and the bottom of the side plate and provided with a stepped insertion surface that is for plug-in mounting and matching the insertion slot.

A second aspect of the invention provides a new energy automobile, provided with a solid oxide fuel cell and a high temperature heat balance component, and an FCM box for rack-mounting the solid oxide fuel cell and the high temperature heat balance component, wherein the solid oxide fuel cell system high-temperature component connecting structure in any of the above paragraphs is arranged among the solid oxide fuel cell, the high temperature heat balance component and the FCM box.

The solid oxide fuel cell system high-temperature component connecting structure provided by the present invention comprises a heat insulation plate, a bottom supporting plate and a fixed mounting plate that are for rack-mounting a high-temperature component and arranged in sequence, and connecting bolts for connecting the heat insulation plate, the bottom supporting plate and the fixed mounting plate are mounted in the high-temperature component; and supporting columns are arranged in the heat insulation plate in the thickness direction of the heat insulation plate and are sleeved on the connecting bolts to bear the locking force of the connecting bolts and counteract the axial expansion amount of the bolts at high temperature. In order to ensure the high-temperature working condition of the solid oxide fuel cell, when a high-temperature component is supported by a bottom supporting plate and a fixed mounting plate, a heat insulation plate is arranged between the high-temperature component and the bottom supporting plate to reduce the heat conduction to the high-temperature component and the heat loss and raise the heat efficiency. Meanwhile, because the heat insulation plate has a low strength and a low thermal expansion coefficient, in order to counteract the axial expansion amount of the bolts during work at high temperature and ensure a stable supporting structure of the heat insulation plate, when the heat insulation plate, the bottom supporting plate and the fixed mounting plate are locked through connecting bolts, supporting columns are arranged in the heat insulation plate in the thickness direction of the heat insulation plate and are sleeved on the connecting bolts to bear the locking force of the connecting bolts to avoid deformation of the heat insulation plate under pressure and ensure the stability of the heat insulation structure.

### BRIEF DESCRIPTION OF THE DRAWINGS

The drawings used in the description of the embodiments will be briefly described below. The drawings in the description below are just some embodiments of the present invention.

FIG. 1 is a structural schematic view of connection of an existing ordinary fuel cell.

FIG. 2 is a structural schematic view of a solid oxide fuel cell system high-temperature component connecting structure.

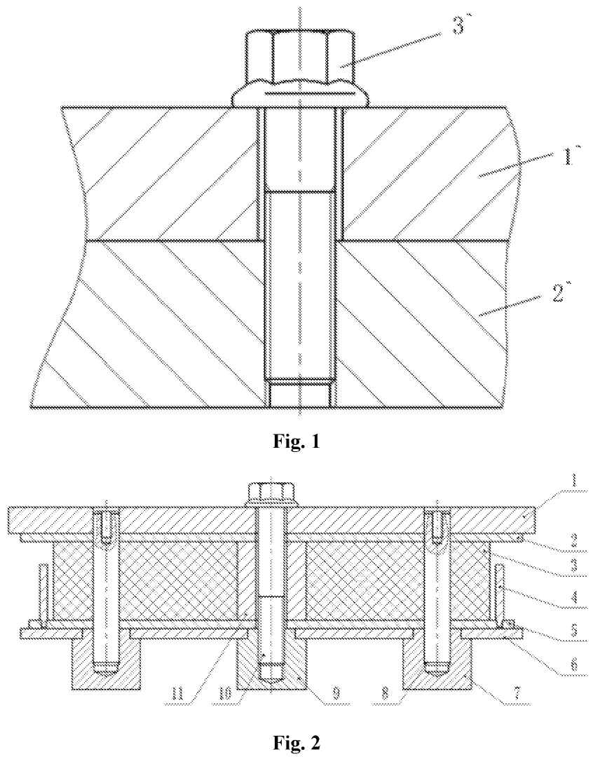

### DETAILED DESCRIPTION

The present invention discloses a solid oxide fuel cell system high-temperature component connecting structure to meet the working stability of high-power fuel cells; and the present invention further provides a new energy automobile.

Embodiments of the present invention will be described below in conjunction with the drawings. The described embodiments are only some, not all of the embodiments of the present invention.

FIG. 2 is a structural schematic view of a solid oxide fuel cell system high-temperature component connecting structure provided by the present The present invention provides a solid oxide fuel cell system high-temperature component connecting structure, comprising a heat insulation plate 3, a bottom supporting plate 5, and a fixed mounting plate 6 that are for rack-mounting a high-temperature component 1 and arranged in sequence. Connecting bolts 10 for connecting the heat insulation plate 3, the bottom supporting plate 5 and the fixed mounting plate 6 are mounted in the high-temperature component 1;. Supporting columns 11 are arranged in the heat insulation plate 3 in the thickness direction of the heat insulation plate 3 and are sleeved on the connecting bolts 10 to bear the locking force of the connecting bolts 10 and counteract the axial expansion amount of the connecting bolts 10 at high temperature. In order to ensure the high-temperature working condition of the solid oxide fuel cell, when a high-temperature component 1 is supported by a bottom supporting plate 5 and a fixed mounting plate 6, a heat insulation plate 3 is arranged between the high-temperature component 1 and the bottom supporting plate 5 to reduce the heat conduction to the high-temperature component 1 and the heat loss and raise the heat efficiency. Meanwhile, because the heat insulation plate has a low strength and a low thermal expansion coefficient, in order to counteract the axial expansion amount of the connecting bolts 10 during work at high temperature and ensure a stable supporting structure of the heat insulation plate 3, when the heat insulation plate 3, the bottom supporting plate 5 and the fixed mounting plate 6 are locked through the connecting bolts 10, supporting columns 11 are arranged in the heat insulation plate 1 in the thickness direction of the heat insulation plate 1 and are sleeved on the connecting bolts 10 to bear the locking force of the connecting bolts 10 to avoid deformation of the heat insulation plate 3 under pressure and ensure the stability of the heat insulation structure.

The supporting columns 11 are sleeve structures sleeved on the connecting bolts 10. The axial direction of the supporting columns 11 is arranged in the thickness direction of the heat insulation plate 3. The two end faces of each supporting column 11 should be flush with the heat insulation plate. The supporting columns 11 bear the locking pressure of the connecting bolts 10 on the heat insulation plate 3, the bottom supporting plate 5 and the fixed mounting plate 6. As the heat insulation plate 3 is weak in strength, this structure can effectively avoid applying the weight of the solid oxide fuel cell directly on the heat insulation plate 3 by the high-temperature component 1, causing deformation or damage of the heat insulation plate 3. Meanwhile, as the thermal expansion coefficient of the heat insulation plate 3 is low, the expansion amount of the heat insulation plate at high temperature cannot counteract the axial expansion amount of the bolts. This structure can effectively avoid loosening of the bolts during operation at high temperature and guarantee the reliability of bolt connection during operation at high temperature.

In a specific embodiment of the present invention, a top supporting plate 2 pressed between the heat insulation plate 3 and the high-temperature component 1 is also provided. The solid oxide fuel cell is supported by the high-temperature component 1, and the heat insulation plate 3 reduces heat loss. If the high-temperature component is light, a certain number of connecting bolts 10 alone on which a corresponding number of supports 11 are sleeved can meet the load-bearing requirements of the high-temperature component 1. After the weight of the high-temperature component increases due to different vehicle models, the connecting bolts 10 alone will bear a greater force, which is liable to causing deformation of the high-temperature component 1 to be pressed on the heat insulation plate 3.

By providing a top supporting plate 2, which serves as a support between the high-temperature component 1 and the heat insulation plate 3, the contact area between the high-temperature component 1 and the supporting columns 11 increases and the unit-area force on the high-temperature component 1 is reduced, thereby improving the stability of the supporting structure of the high-temperature component 1 and the safety of the heat insulation plate 3. The two surfaces of the top supporting plate 2 are pressed between the heat insulation plate 3 and the high-temperature component 1 to guarantee the stability of the supporting structure.

In one embodiment of the present invention, two guide pin locating holes are also arranged in the supporting direction of the heat insulation plate 3, the bottom supporting plate 5 and the fixed mounting plate 6, are distributed on two sides of the connecting bolts 10 in the radial direction of the connecting bolts 10 and use cylindrical guide pins 8 to locate the installation of the connecting bolts 10 and supporting plates. The heat insulation plate 3, the bottom supporting plate 5 and the fixed mounting plate 6 are locked and located through the connecting bolts 10. The high-temperature component 1 presses the solid oxide fuel cell on the bottom supporting plate 5 and the fixed mounting plate 6 via the connecting bolts 10 and the supporting columns 11, so the connecting bolts 10 only need to bear an axial force, avoiding generation of a shear force.

In some embodiments, in order to ensure the connection strength, at least three connecting bolts are needed, and the specific number depends on actual needs;. The positions of the two cylindrical guide pins can be determined according to needs.

When the high-temperature component 1 is mounted on the fixed mounting plate 6 via the heat insulation plate 3 and the bottom supporting plate 5, the two guide pin locating holes and the cylindrical guide pins 8 are used for mounting and locating, so that the bolt holes of the connecting bolts 10 are kept consistent in the axial direction. After the high-temperature component 1 is locked and connected by the connecting bolts 10, the cylindrical guide pins 8 are removed from the inside of the guide pin locating holes to avoid the heat loss of the high-temperature component 1 caused by the cylindrical guide pins 8.

In one embodiment of the present invention, screw seats 9 that are for locking and matching the connecting bolts 10 by means of threads are mounted on the bottom of the fixed mounting plate 6 in a fixed manner. The fixed mounting plate 6 is a plate-like structure. It is difficult to ensure the connection strength by the match between the fixed mounting plate 6 and the connecting bolts 10. The match with nuts raises the installation difficulty of the connecting bolts. By pre-arranging the screw seats 9 on the fixed mounting plate 6 and directly locking and connecting the connecting bolts 10 with the screw seats 9 when the connecting bolts 10 pass through the high-temperature component 1 for connection, the installation difficulty is reduced.

Accordingly, hole seats 7 that are for mounting and matching the cylindrical guide pins 8 are also mounted on the bottom of the fixed mounting plate 6 in a fixed manner. In order to avoid titling and deformation of the cylindrical guide pins 8 in the process of locating the top supporting plate 2, the heat insulation plate 3, the bottom supporting plate 5 and the fixed mounting plate 6, two hole seats 7 corresponding to the positions of the two guide pin locating holes are mounted on the fixed mounting plate 6 in a fixed manner to assure the stability of the locating structure of the cylindrical guide pins 8 and the hole seats 7 and further guarantee the supporting strength of the high-temperature component. The arrangement structure of the screw seats 9 ensures the connection strength while effectively reducing the thickness of the fixed mounting plate 6 and lessening the weight.

In one embodiment of the present invention, locating holes for mounting and locating the screw seats 9 and the hole seats 7 are opened on the fixed mounting plate 6, locating steps for plug-in mounting and matching the locating holes are opened on the screw seats 9 and the hole seats 7, and the screw seats 9 and the hole seats 7 are all mounted on the fixed mounting plate 6 by means of welding. In order to ensure the stability of the locating structure of the screw seats 9 and the hole seats 7, the fixed mounting plate 6 adopts locating holes for mounting the screw seats 9 and the hole seats 7 to guarantee position accuracy. The screw seats 9 and the hole seats 7 are structurally consistent except that the structures of the holes opened on them are different. After locating holes are opened on the fixed mounting plate 6, locating steps are arranged on the mounting ends of the screw seats 9 and the hole seats 7 and inserted in the locating holes and then are fixed by means of welding to ensure structural stability of the connecting bolts.

In one embodiment of the present invention, a side plate 4 is extended from the bottom supporting plate 5, is around the circumference of the heat insulation plate 3 and protects the heat insulation plate 3. The material of the heat insulation plate 3 has poor strength. In order to avoid deformation, even rupture of the heat insulation plate after long-time compression, a side plate around the circumference of the heat insulation plate 3 is mounted on the bottom supporting plate 5 in a fixed manner. The side plate 4 wraps and protects the heat insulation plate 3, reduces the outward dispersion of the heat insulation plate in case of rupture or deformation of the heat insulation plate 3 and assures a heat insulation effect to some extent.

Further, an insertion slot arranged in parallel with the circumference of the heat insulation plate 3 is opened on the bottom supporting plate 5, and the bottom of the side plate 4 is provided with a stepped insertion surface that is for plug-in mounting and matching the insertion slot. The side plate 4 is fixed to the bottom supporting plate 5 in form of an insert, the bottom supporting plate 5 is provided with an insertion slot, and the bottom of the side plate 4 is provided with a stepped insertion surface to ensure the limiting ability of the side plate when it is pressed.

Because the connecting bolts 10, the top supporting plate 2, the bottom supporting plate 5 and the fixed mounting plate 6 in this embodiment are all in a high temperature environment, the connecting bolts 10 comprise special bolts to ensure the connection strength of the supporting columns 11 at high temperature. The expansion coefficients of the connecting bolts 10 and the supporting columns 11 are close to ensure that under a high temperature working environment, their axial thermal expansion offsets the axial thermal expansion amount of the bolts, preventing loosening of the bolts during operation and ensuring connection reliability and stability. The expansion coefficient of the bolts can be less than the expansion coefficient of the supporting columns.

The fixed mounting plate, the top supporting plate and the bottom supporting plate should be made of materials that are resistant to corrosion and high temperature, have high strength, and do not contain phosphorus (P), sulfur (S), lithium (Li), barium (Ba) and heavy metal elements, so as to avoid volatilization of elements at high temperature, which will adversely affect the system catalyst.

The present invention further provides a new energy automobile, provided with a solid oxide fuel cell and a high temperature heat balance component, and an FCM box for rack-mounting the solid oxide fuel cell. The connecting structure among the solid oxide fuel cell, the high temperature heat balance component and the FCM box, which is arranged on the new energy automobile is the solid oxide fuel cell system high-temperature component connecting structure provided by the foregoing embodiment.

Various modifications to these embodiments will be obvious to those skilled in the art. The general principle defined herein can be implemented in other embodiments without departing from the scope of the present invention.

1. A solid oxide fuel cell system high-temperature component connecting structure, comprising:
a heat insulation plate,
a bottom supporting plate and a fixed mounting plate that are for rack-mounting a high-temperature component and arranged in sequence, and
connecting bolts for connecting the heat insulation plate, the bottom supporting plate and the fixed mounting plate are mounted in the high-temperature component; and
wherein supporting columns are arranged in the heat insulation plate in the thickness direction of the heat insulation plate and are sleeved on the connecting bolts to bear the locking force of the connecting bolts and counteract the axial expansion amount of the connecting bolts at high temperature.

2. The solid oxide fuel cell system high-temperature component connecting structure according to claim 1, further comprising a top supporting plate pressed between the heat insulation plate and the high-temperature component.

3. The solid oxide fuel cell system high-temperature component connecting structure according to claim 1, further comprising:
two guide pin locating holes arranged in the supporting direction of the heat insulation plate, the bottom supporting plate, and the fixed mounting plate, and distributed on two sides of the connecting bolts in the radial direction of the connecting bolts; and
cylindrical guide pins to locate the installation of the connecting bolts.

4. The solid oxide fuel cell system high-temperature component connecting structure according to claim 1, comprising screw seats for locking and matching the connecting bolts by means of threads mounted on the bottom of the fixed mounting plate in a fixed manner.

5. The solid oxide fuel cell system high-temperature component connecting structure according to claim 4, further comprising hole seats for mounting and matching the cylindrical guide pins mounted on the bottom of the fixed mounting plate in a fixed manner.

6. The solid oxide fuel cell system high-temperature component connecting structure according to claim 5, wherein:
locating holes for mounting and locating the screw seats and the hole seats are provided in the fixed mounting plate,
locating steps for plug-in mounting and matching the locating holes are provided in the screw seats and the hole seats, and
the screw seats and the hole seats are all mounted on the fixed mounting plate by means of welding.

7. The solid oxide fuel cell system high-temperature component connecting structure according to claim 1, wherein a side plate extends from the bottom supporting plate around the circumference of the heat insulation plate and protects the heat insulation plate.

8. The solid oxide fuel cell system high-temperature component connecting structure according to claim 7, wherein an insertion slot arranged in parallel with the circumference of the heat insulation plate is provided in the bottom supporting plate, and the bottom of the side plate is provided with a stepped insertion surface that is for plug-in mounting and matching the insertion slot.

9. The solid oxide fuel cell system high-temperature component connecting structure according to claim 1, wherein the thermal expansion coefficient of the connecting bolts is less than the thermal expansion coefficient of the supporting columns.

10. A new energy automobile, provided with a solid oxide fuel cell and a high temperature heat balance component, and an FCM box for rack-mounting the solid oxide fuel cell and the high temperature heat balance component, wherein the solid oxide fuel cell system high-temperature component connecting structure in claim 1 is arranged among the solid oxide fuel cell, the high temperature heat balance component and the FCM box.
